(19) United States
(12) Patent Application Publication
(10) Pub. No.: US 2023/0171592 A1
(43) Pub. Date: Jun. 1, 2023

(54) ENHANCING RAN UE ID BASED UE IDENTIFICATION IN O-RAN

(71) Applicant: Intel Corporation, Santa Clara, CA (US)

(72) Inventors: Jaemin HAN, Portland, OR (US); Leifeng RUAN, Beijing (CN); Dawei YING, Hillsboro, OR (US)

(21) Appl. No.: 17/921,296

(22) PCT Filed: Jun. 8, 2021
(86) PCT No.: PCT/US2021/036329

§ 371 Date: Oct. 25, 2022

Related U.S. Application Data
(60) Provisional application No. 63/036,882, filed on Jun. 9, 2020.

(51) Int. Cl. H04W 8/26; H04W 8/18

(52) U.S. Cl. CPC H04W 8/26; H04W 8/18

(57) ABSTRACT

This invention related to an apparatus comprising memory to store updated radio access network (RAN) user equipment (UE) identification (ID) information, and processing circuitry, coupled with the memory, to: receive, from a near-real time RAN intelligent controller (near-RT RIC), a subscription or request for the updated RAN UE ID information; retrieve the updated RAN UE ID information from the memory; and encode a message for transmission to the near-RT RIC that includes the updated RAN UE ID information.

### CROSS REFERENCE TO RELATED APPLICATION

The present application claims priority to U.S. Provisional Patent Application No. 63/036,882, which was filed Jun. 9, 2020.

### FIELD

Various embodiments generally may relate to the field of wireless communications.

### BACKGROUND

The Open RAN (O-RAN) architecture currently being developed aims to optimize overall system performance and improve user experiences in 3GPP networks. As illustrated in FIG. 1 below, two RAN intelligence controllers (RIC)—non real-time (non-RT) and near real-time (Near-RT), were introduced to provide optimized controls over RAN nodes, based on artificial intelligence (AI) and machine learning (ML).

In order to improve experience of a UE, it is important that a UE of interest is identified, while connected to the 3GPP network, across SMO/non-RT RIC and Near-RT RIC, and also across O1, A1, and E2 interfaces.

Among many UE identifiers within 3GPP network, it was proposed to use a RAN UE ID (defined in TS 38.473, v. 16.1.0, 2020 Mar. 31; and TS 38.463, v. 16.1.1, 2020 Mar. 31) as a common identifier over O1, A1, and E2 interfaces. Currently, A1 policy (from Non-RT RIC to Near-RT RIC) for a UE is specified to be identified by the RAN UE ID. Based on that, it was proposed to fill the gap, by making RAN nodes update the RAN UE ID of a UE to SMO via O1 and to Near-RT RIC via E2, whenever assigned (or re-assigned) or de-assigned.

While this framework works for the purpose of UE identification, we see some inefficiencies observed that can be further optimized. Among other things, embodiments of the present disclosure may be directed to enhancements for this RAN UE ID based UE identification in existing O-RAN systems.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of an O-RAN architecture in accordance with various embodiments.

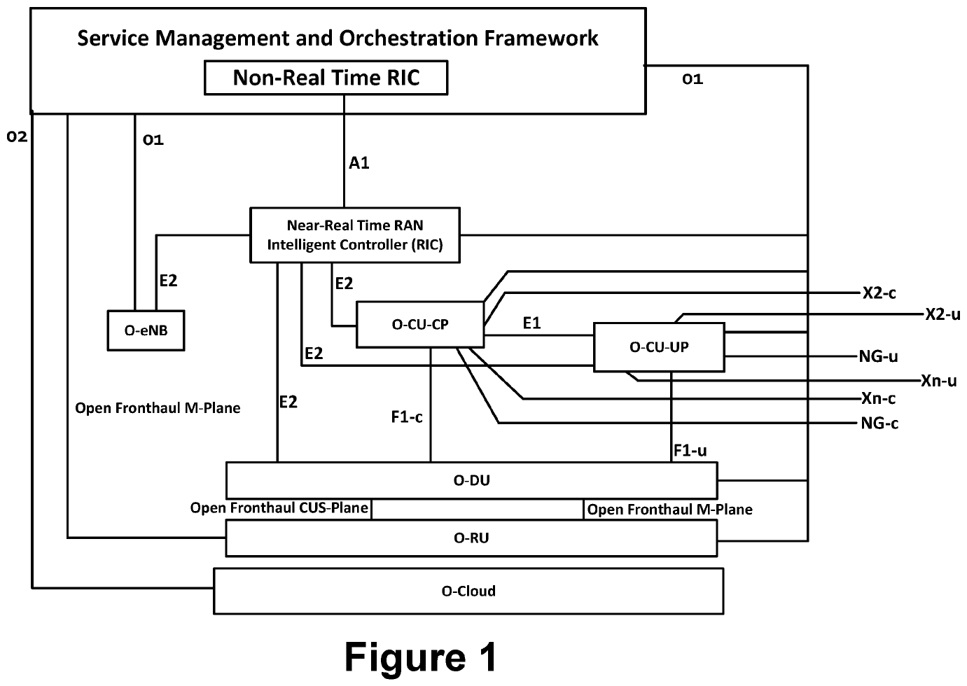

FIG. 2 illustrates a network in accordance with various embodiments.

FIG. 3 schematically illustrates a wireless network in accordance with various embodiments.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein.

FIG. 5 illustrates an example of a high-level view of an Open RAN (O-RAN) architecture in accordance with various embodiments.

FIG. 6 illustrates an example of an O-RAN logical architecture corresponding to the O-RAN architecture of FIG. 5.

FIG. 7 depicts an example procedure for practicing the various embodiments discussed herein.

FIG. 8 depicts another example procedure for practicing the various embodiments.

FIG. 9 depicts another example procedure for practicing the various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).
1. Subscription based UE observability from RAN nodes to Near-RT RIC: A UE observability based on RAN UE ID (whenever (re/de)assigned) is currently proposed via O1 to SMO and via E2 to Near-RT RIC. While the observability over O1 is baseline, for e.g.—a performance monitoring (PM) perspective, not every UE currently served by a RAN node is always the subject of an optimization or RAN intent that the operator wants to achieve. It would not be desirable for Near-RT RIC to maintain, for every single RAN node, UE contexts of all the UEs and their RAN UE IDs connected to it. In fact, based on xApps or A1 polices, only a subset of UEs may be subject to. Therefore, there should be some mechanisms for Near-RT RIC to subscribe or request an update of a RAN UE ID (whenever (re/de)assigned) based on UE group/categories of interest over E2 interface.
2. RAN UE ID update together with gNB-DU ID and gNB-CU-UP ID: When a UE accesses a gNB, especially in case of CU-DU split or CP-UP separated, a RAN UE ID is assigned by the gNB-CU-CP and shared with gNB-DU and gNB-CU-UP when the UE context is created. Currently, it is assumed that a RAN UE ID is updated from gNB-CU-CP, however, providing this ID alone lacks observability of which gNB-DU and which gNB-CU-UP are serving the same UE in case of CU-DU split or CP-UP separated. One may argue that a Near-RT RIC can know if all those entities (gNB-CU-CP, gNB-CU-UP, gNB-DU) updates the same RAN UE ID to the Near-RT RIC, but given that the same value is always shared between those entities while the UE is in connected, it would be more efficient if the gNB-CU-CP takes charge of the RAN UE ID update, together with the corresponding gNB-DU UE ID and gNB-CU-UP UE ID that may be changed during intra-gNB mobility.

The present disclosure proceeds by describing embodiments to enhance the RAN UE ID based UE identification method proposed for existing O-RAN systems.

### Embodiment 1: Subscription Based UE Observability from RAN Nodes to Near-RT RIC

Some examples of implementations for O-RAN E2 interface SM (Service Model) specifications are as follows:

///////////////some operations skipped//////////////////////

### 7.3 Event Trigger Definition Styles

### 7.3.1 RIC Event Trigger Definition IE Style List

| RIC | | Supported RIC | | | |
|---|---|---|---|---|---|
| Style | Style | Service Style | | | |
| Type | Name | Report | Insert | Policy | Style Description |
| 1 | Interface | 1, 2 | 1 | 1 | RIC Event trigger |
| | Message | | | | definition IE based |
| | Event | | | | on arrival of defined |
| | | | | | message |
| 2 | RAN UE | 3 | | | RIC Event trigger |
| | Group | | | | definition IE based |
| | Event | | | | on definition of UE |
| | | | | | group that are |
| | | | | | currently served |
| | | | | | by the E2 node |

### 7.3.2 RIC Event Trigger Definition IE Style 1: Interface Message Event

This RIC Event Trigger Definition IE style 1 is used to detect a specific interface message event in E2 Node RAN Function based on specified target Network Interface Type, Network Interface Identifier, Network Interface Direction, Network Interface Message Type, Message Protocol IE Identifier, Message Protocol IE Test Condition and Message Protocol IE Test Value.

This RIC Event Trigger Definition IE style 1 uses RIC Event Trigger Definition IE Format 1 (8.2.1.1.1)

### 7.3.3 RIC Event Trigger Definition IE Style 2: RAN UE Group Event

This RIC Event Trigger Definition IE style 2 is used to detect a specific group of UEs that are currently being served by the E2 nodes based on the configured RAN UE group conditions.

This RIC Event Trigger Definition IE style uses RIC Event Trigger Definition IE Format 2 (8.2.1.1.2)

### 7.4 Supported RIC REPORT Service Styles

### 7.4.1 REPORT Service Style List

| RIC Style | | |
|---|---|---|
| Type | Style Name | Style Description |
| 1 | Complete message | Used to send copy of complete |
| | | message from E2 Node RAN Function |
| 2 | Partial message | Used to send copy of part of |
| | | message from E2 Node RAN Function |
| 3 | RAN UE ID | Used to send RAN UE IDs of |
| | | specific UEs from E2 Node RAN Function |

### 7.4.2 REPORT Service Style 1: Complete Message

### 7.4.2.1 REPORT Service Style Description

This REPORT Service style provides a copy of a complete network interface message with the network interface specific encoded message carried as a transparent container with an associated header providing information on the target Network Interface Type, Network Interface Identifier, Network Interface Direction and optional Network Interface Timestamp. The addition of optional information time stamp in the Indication Header is controlled using the associated RIC Action Parameter

### 7.4.2.2 REPORT Service RIC Action Definition IE Contents

This REPORT Service style uses the following RAN parameters with RIC Action Definition IE Format 1 (8.2.1.2.1) where AddTimestamp is used to request the inclusion of optional Network Interface Timestamp information in RIC Indication header IE:

| RAN | RAN | RAN | |
|---|---|---|---|
| Parameter | Parameter | Parameter | |
| ID | Name | Type | Parameter description |
| 1 | AddTimestamp | BOOLEAN | TRUE = Use optional |
| | | | Network Interface Timestamp |
| | | | in RIC Indication Header |

### 7.4.2.3 REPORT Service RIC Indication Header IE Contents

REPORT Service RIC Indication Header IE contains the Network Interface Type, Network Interface Identifier, Network Interface Direction and optional Network Interface Timestamp.

This REPORT Service style uses RIC Indication header IE Format 1 (8.2.1.3.1)

### 7.4.2.4 REPORT Service RIC Indication Message IE Contents

REPORT Service RIC Indication message IE contains contains a transparent container used to carry the complete message with contents defined by the specific network interface specification.

This REPORT Service style uses RIC Indication message IE Format 1 (8.2.1.4.1)

### 7.4.3 REPORT Service Style 2: Partial Message

### 7.4.3.1 REPORT Service Style Description

This REPORT Service style provides a copy of a specific information element extracted from a network interface message with the network interface specific encoded message carried as a transparent container associated with an indication header providing information on the target Network Interface Type, Network Interface Identifier, Network Interface Direction, Network Interface Message Type and optional Network Interface Timestamp. The addition of optional Network Interface Timestamp in the Indication Header and the rules for extracting the part of the message are controlled using the associated RIC Action Parameter

### 7.4.3.2 REPORT Service RIC Action Definition IE Contents

This REPORT Service style uses the following RAN parameters with RIC Action Definition IE Format 1 (8.2.1.2.1) where AddTimestamp is used to request the inclusion of optional Timestamp information in RIC Indication header IE and Target Protocol IE Identifier is used to specify the required IE to be copied from the message.

| RAN | RAN | RAN | |
|---|---|---|---|
| Parameter | Parameter | Parameter | |
| ID | Name | Type | Parameter description |
| 1 | AddTimestamp | BOOLEAN | TRUE = Use optional Network Interface |
| | | | Timestamp in RIC Indication Header |
| 2 | Target | INTEGER | Identifies the target Protocol IE identifier to be |
| | Protocol IE | | copied from the message and sent in Indication |
| | Identifier | | Message IE. Specified in terms of Protocol IE ID |
| | | | using the definition of the specific network |
| | | | interface type |

### 7.4.3.3 REPORT Service RIC Indication Header IE Contents

REPORT Service RIC Indication Header IE contains the Network Interface Type, Network Interface Identifier, Network Interface Direction and optional Network Interface Timestamp.

This REPORT Service style uses RIC Indication header IE Format 1 (8.2.1.3.1)

### 7.4.3.4 REPORT Service RIC Indication Message IE Contents

REPORT Service RIC Indication message IE contains a transparent container used to carry the extracted part of the message with contents defined by the specific network interface specification.

This REPORT Service style uses RIC Indication message IE Format 1 (8.2.1.4.1)

### 7.4.4 REPORT Service Style 3: RAN UE ID

### 7.4.4.1 REPORT Service Style Description

This REPORT Service style provides RAN UE IDs of specific UEs currently served by the E2 node that match the configured RAN UE group conditions.

### 7.4.3.2 REPORT Service RIC Indication Message IE Contents

REPORT Service RIC Indication message IE contains a list of RAN UE IDs of the UEs that are currently being served by the E2 node, per each RAN UE group requested.

This REPORT Service style uses RIC Indication message IE Format 1 (8.2.1.4.2)

////////////////////////some operations skipped//////////////////////////

### 7.8 Supported RIC Service Styles and E2SM IE Formats

Table 7.8-1 and 7.8-2 provide a summary of the E2SM IE Formats defined to support the set of RIC Event Triggers and RIC Service Styles defined in this E2SM specification.

TABLE 7.8-1
Summary of the E2SM IE encoding Formats
defined to support the set of RIC
Event Trigger styles

| RIC | Event Trigger |
|---|---|
| Service | Definition |
| and Style | Format |

Event Trigger

| | |
|---|---|
| Style 1 | 1 |
| Style 2 | 2 |

TABLE 7.8-1
Summary of the E2SM IE encoding Formats defined
to support the set of RIC Service Styles

| | | | | | | |
|---|---|---|---|---|---|---|
| RIC | | | | Call | | |
| Service | Action | Indication | Indication | Process | Control | Control |
| and | Definition | header | message | ID | header | message |
| Style | Format | Format | Format | Format | Format | Format |

REPORT

| | | | |
|---|---|---|---|
| Style 1 | 1 | 1 | 1 |
| Style 2 | 1 | 1 | 1 |
| Style 3 | | | 2 |

INSERT

| | | | | |
|---|---|---|---|---|
| Style 1 | 1 | 1 | 1 | 1 |

CONTROL

| | | | |
|---|---|---|---|
| Style 1 | 1 | 1 | 1 |

POLICY

| | |
|---|---|
| Style 1 | 2 |

//////////////////////some operations skipped///////////////////////////

### 8.2 Message Functional Definition and Content

### 8.2.1 Messages for RIC Functional Procedures

////////////////////////some operations skipped/////////////////////////////

### 8.2.1.1 RIC Event Trigger Definition IE

This information element is part of the RIC SUBSCRIPTION REQUEST message sent by the Near-RT RIC to a E2 Node and is required for event triggers used to initiate REPORT, INSERT and POLICY actions.

Direction: Near-RT RIC→E2 Node.

| | | | IE type and | Semantics |
|---|---|---|---|---|
| lE/Group Name | Presence | Range | reference | description |
| CHOICE Format | | | | |
| >E2SM-NI Event | M | | 8.2.1.1.1 | |
| Trigger Definition | | | | |
| Format 1 | | | | |
| >E2SM-NI Event | M | | 8.2.1.1.2 | |
| Trigger Definition | | | | |
| Format 2 | | | | |

8.2.1.1.1 E2SM-NI Event Trigger Definition Format 1

This RIC Event Trigger Definition style allows to select a specific target using:
Network Interface Type IE used to select a specific interface type,
Network Interface Identifier used to select a specific interface instance,
Network Interface Direction used to select a specific interface direction (incoming or outgoing),
Network Interface Message Type used to select a specific message on the interface,
Message Protocol IE Identifier used to select a specific protocol element in the selected message,
Message Protocol IE Test Condition and Message Protocol IE Test Value are used to test if the selected protocol element meets a specific test condition where the trigger condition applies when and only if all of the test conditions are TRUE (e.g., logical ADD of each test condition).

| | | | IE type and | Semantics |
|---|---|---|---|---|
| lE/Group Name | Presence | Range | reference | description |
| Network Interface Type | M | | 8.3.21 | |
| Network Interface | O | | 8.3.22 | “Any” instance to be |
| Identifier | | | | used if absent |
| Network Interface | O | | 8.3.23 | “Both” directions to |
| Direction | | | | be used if absent |
| Network Interface | O | | 8.3.25 | “Any” message type |
| Message Type | | | | to be used if absent |
| Sequence of Message | | 0.. <maxof | | “Any” message if |
| Protocol Tests | | Interface | | zero message |
| | | Protocol | | protocol tests in list |
| | | Test> | | |
| >Message Protocol | M | | 8.3.26 | Protocol IE ID |
| IE ID | | | | presence in message |
| | | | | if test condition is |
| | | | | absent |
| >Message Protocol | O | | 8.3.27 | |
| IE Test condition | | | | |
| >Message Protocol | O | | 8.3.28 | Shall be included if |
| IE Value | | | | test condition is |
| | | | | present |

| Range bound | Explanation |
|---|---|
| maxof Interface Protocol Test | Maximum no. of Network Interface Protocol |
| | Test in event trigger definition supported |
| | by RAN Function. Value is <15> |

### 8.2.1.1.2 E2SM-NI Event Trigger Definition Format 2

The E2SM-NI Event Trigger Definition IE Format 2 supports a REPORT encoded as a list of RAN UE Groups, each with a group identifier, group definition described in terms of a list of RAN parameters with test conditions, in order to retrieve the RAN UE IDs of the UEs that are currently served by the E2 node which match the test conditions configured per each group.

| | | | IE type and | Semantics |
|---|---|---|---|---|
| lE/Group Name | Presence | Range | reference | description |
| Sequence of RAN UE | | 0..<maxofRA | | |
| Group | | NueGroups> | | |
| >RAN UE Group ID | M | | 8.3.14 | |
| >RAN UE Group | M | | 8.3.15 | Defines RAN |
| Definition | | | | UE group |

| Range bound | Explanation |
|---|---|
| maxofRANueGroups | Maximum no. of RAN UE Groups |
| | in action definition supported by |
| | RAN Function. Value is 255. |

///////////////////////some operations skipped////////////////////////

### 8.2.1.4 RIC Indication Message IE

This information element is part of the RIC INDICATION message sent by the E2 Node to a Near-RT RIC node and is required for REPORT and INSERT actions.

Direction: E2 Node→Near-RT RIC.

| | | | IE type and | Semantics |
|---|---|---|---|---|
| IE/Group Name | Presence | Range | reference | description |
| CHOICE Format | | | | |
| >E2SM-NI Indication | M | | 8.2.1.4.1 | |
| Message Format 1 | | | | |
| E2SM-NI Indication | M | | 8.2.1.4.2 | |
| Message Format 2 | | | | |

### 8.2.1.4.1 E2SM-NI Indication Message Format 1

Content is encoded as per definition of network interface type indicated in the Network Interface Type IE in associated RIC Indication Header IE.

| | | | IE type and | Semantics |
|---|---|---|---|---|
| lE/Group Name | Presence | Range | reference | description |
| Network Interface | M | | 8.3.29 | |
| Message | | | | |

### 8.2.1.4.2 E2SM-NI Indication Message Format 2

Content is encoded as a list of RAN UE IDs of the UEs that are currently being served by the E2 node, per each RAN UE group requested.

| | | | IE type and | Semantics |
|---|---|---|---|---|
| IE/Group Name | Presence | Range | reference | description |
| Sequence of RAN UE | | 0..<maxofRA | | |
| Group | | NueGroups> | | |
| >RAN UE Group ID | M | | 8.3.14 | |
| Sequence of RAN | | 0..<maxofRA | | |
| UE IDs | | NueIDs> | | |
| >>RAN UE ID | M | | OCTET STRING | |
| | | | (SIZE (8)) | |

| Range bound | Explanation |
|---|---|
| maxofRANueGroups | Maximum no. of RAN UE Groups supported |
| | by RAN Function. Value is 255. |
| MaxofRANueIDs | Maximum no. of RAN UE IDs supported |
| | by RAN Function. Value is 2⁶⁴-1. |

### Embodiment 2: RAN UE ID Update Together with gNB-DU ID and gNB-CU-UP ID

Some examples of implementations for O-RAN E2 interface AP (Application Protocol) specification are as follows:

### 9.2.XXRAN UE ID

This information element indicates the RAN UE ID assigned by the gNB(-CU-CP) for a UE and optionally the ID(s) of an associated gNB-DU and/or gNB-CU-UP that the corresponding UE contexts are established.

| | | | | Semantics |
|---|---|---|---|---|
| IE/Group Name | Presence | Range | IE type and reference | description |
| RAN UE ID | M | | OCTET STRING (SIZE | |
| | | | (8)) | |
| gNB-CU-UP ID | O | | 3 GPP 38.463 clause | |
| | | | 9.3.1.15 | |
| gNB-DU ID | O | | 3 GPP 38.473 clause | |
| | | | 9.3.1.9 | |

### Systems and Implementations

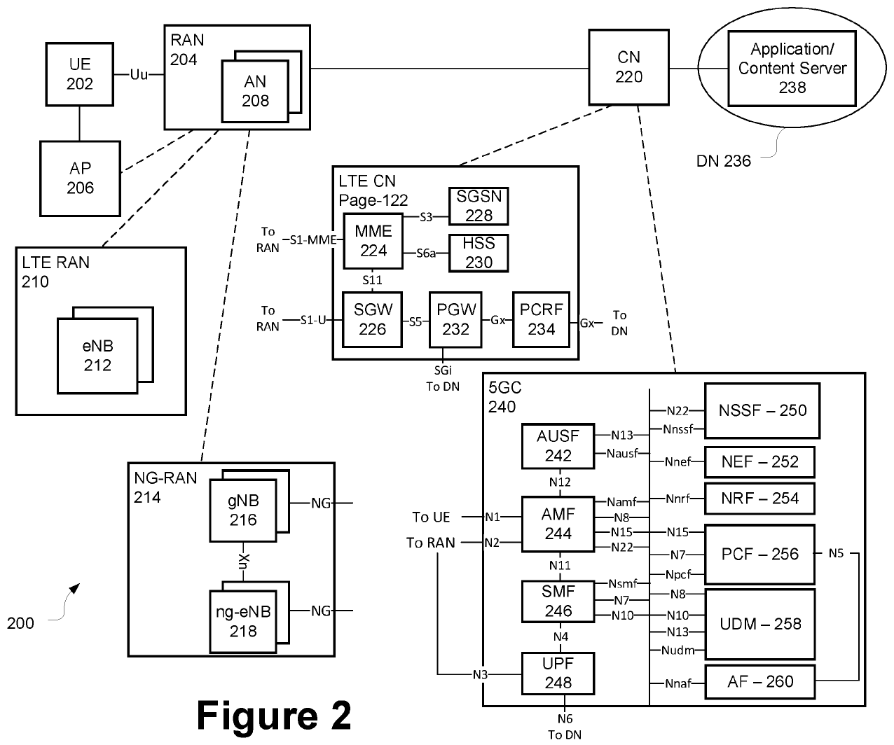

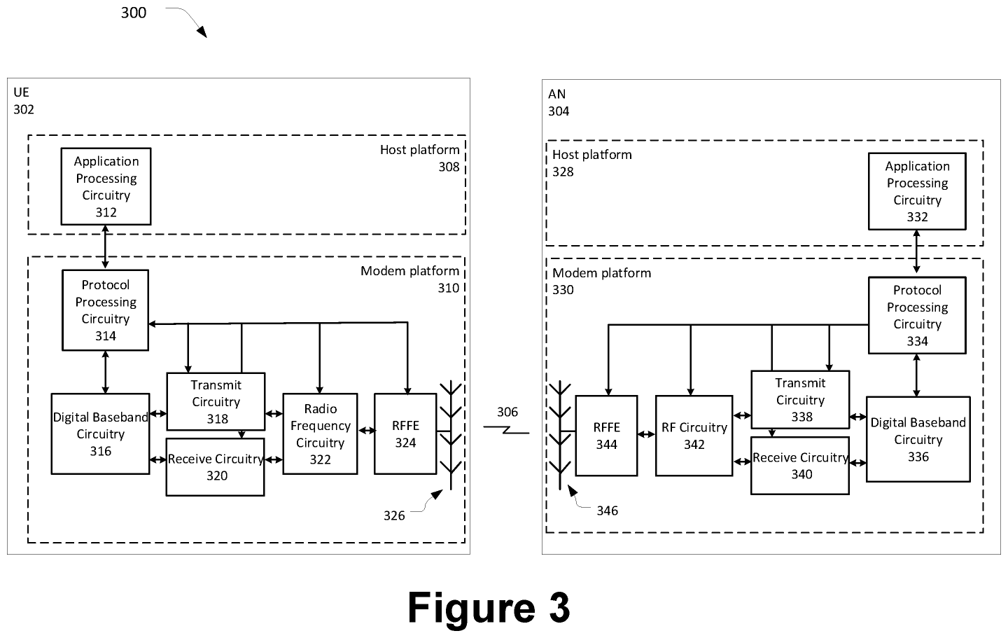

FIGS. 2-3 illustrate various systems, devices, and components that may implement aspects of disclosed embodiments.

FIG. 2 illustrates a network 200 in accordance with various embodiments. The network 200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 200 may include a UE 202, which may include any mobile or non-mobile computing device designed to communicate with a RAN 204 via an over-the-air connection. The UE 202 may be communicatively coupled with the RAN 204 by a Uu interface. The UE 202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 202 may additionally communicate with an AP 206 via an over-the-air connection. The AP 206 may manage a WLAN connection, which may serve to offload some/all network traffic from the RAN 204. The connection between the UE 202 and the AP 206 may be consistent with any IEEE 802.11 protocol, wherein the AP 206 could be a wireless fidelity (Wi-Fi®) router. In some embodiments, the UE 202, RAN 204, and AP 206 may utilize cellular-WLAN aggregation (for example, LWA/LWIP). Cellular-WLAN aggregation may involve the UE 202 being configured by the RAN 204 to utilize both cellular radio resources and WLAN resources.

The RAN 204 may include one or more access nodes, for example, AN 208. AN 208 may terminate air-interface protocols for the UE 202 by providing access stratum protocols including RRC, PDCP, RLC, MAC, and L1 protocols. In this manner, the AN 208 may enable data/voice connectivity between CN 220 and the UE 202. In some embodiments, the AN 208 may be implemented in a discrete device or as one or more software entities running on server computers as part of, for example, a virtual network, which may be referred to as a CRAN or virtual baseband unit pool. The AN 208 be referred to as a BS, gNB, RAN node, eNB, ng-eNB, NodeB, RSU, TRxP, TRP, etc. The AN 208 may be a macrocell base station or a low power base station for providing femtocells, picocells or other like cells having smaller coverage areas, smaller user capacity, or higher bandwidth compared to macrocells.

In embodiments in which the RAN 204 includes a plurality of ANs, they may be coupled with one another via an X2 interface (if the RAN 204 is an LTE RAN) or an Xn interface (if the RAN 204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 204 may each manage one or more cells, cell groups, component carriers, etc. to provide the UE 202 with an air interface for network access. The UE 202 may be simultaneously connected with a plurality of cells provided by the same or different ANs of the RAN 204. For example, the UE 202 and RAN 204 may use carrier aggregation to allow the UE 202 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 202 or AN 208 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 204 may be an LTE RAN 210 with eNBs, for example, eNB 212. The LTE RAN 210 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 204 may be an NG-RAN 214 with gNBs, for example, gNB 216, or ng-eNBs, for example, ng-eNB 218. The gNB 216 may connect with 5G-enabled UEs using a 5G NR interface. The gNB 216 may connect with a 5G core through an NG interface, which may include an N2 interface or an N3 interface. The ng-eNB 218 may also connect with the 5G core through an NG interface, but may connect with a UE via an LTE air interface. The gNB 216 and the ng-eNB 218 may connect with each other over an Xn interface.

In some embodiments, the NG interface may be split into two parts, an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN 214 and an AMF 244 (e.g., N2 interface).

The NG-RAN 214 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 202 can be configured with multiple BWPs where each BWP configuration has a different SCS. When a BWP change is indicated to the UE 202, the SCS of the transmission is changed as well. Another use case example of BWP is related to power saving. In particular, multiple BWPs can be configured for the UE 202 with different amount of frequency resources (for example, PRBs) to support data transmission under different traffic loading scenarios. A BWP containing a smaller number of PRBs can be used for data transmission with small traffic load while allowing power saving at the UE 202 and in some cases at the gNB 216. A BWP containing a larger number of PRBs can be used for scenarios with higher traffic load.

The RAN 204 is communicatively coupled to CN 220 that includes network elements to provide various functions to support data and telecommunications services to customers/subscribers (for example, users of UE 202). The components of the CN 220 may be implemented in one physical node or separate physical nodes. In some embodiments, NFV may be utilized to virtualize any or all of the functions provided by the network elements of the CN 220 onto physical compute/storage resources in servers, switches, etc. A logical instantiation of the CN 220 may be referred to as a network slice, and a logical instantiation of a portion of the CN 220 may be referred to as a network sub-slice.

In some embodiments, the CN 220 may be an LTE CN 222, which may also be referred to as an EPC. The LTE CN 222 may include MME 224, SGW 226, SGSN 228, HSS 230, PGW 232, and PCRF 234 coupled with one another over interfaces (or “reference points”) as shown. Functions of the elements of the LTE CN 222 may be briefly introduced as follows.

The MME 224 may implement mobility management functions to track a current location of the UE 202 to facilitate paging, bearer activation/deactivation, handovers, gateway selection, authentication, etc.

The SGW 226 may terminate an S1 interface toward the RAN and route data packets between the RAN and the LTE CN 222. The SGW 226 may be a local mobility anchor point for inter-RAN node handovers and also may provide an anchor for inter-3GPP mobility. Other responsibilities may include lawful intercept, charging, and some policy enforcement.

The SGSN 228 may track a location of the UE 202 and perform security functions and access control. In addition, the SGSN 228 may perform inter-EPC node signaling for mobility between different RAT networks; PDN and S-GW selection as specified by MME 224; MME selection for handovers; etc. The S3 reference point between the MME 224 and the SGSN 228 may enable user and bearer information exchange for inter-3GPP access network mobility in idle/active states.

The HSS 230 may include a database for network users, including subscription-related information to support the network entities' handling of communication sessions. The HSS 230 can provide support for routing/roaming, authentication, authorization, naming/addressing resolution, location dependencies, etc. An S6a reference point between the HSS 230 and the MME 224 may enable transfer of subscription and authentication data for authenticating/authorizing user access to the LTE CN 220.

The PGW 232 may terminate an SGi interface toward a data network (DN) 236 that may include an application/content server 238. The PGW 232 may route data packets between the LTE CN 222 and the data network 236. The PGW 232 may be coupled with the SGW 226 by an S5 reference point to facilitate user plane tunneling and tunnel management. The PGW 232 may further include a node for policy enforcement and charging data collection (for example, PCEF). Additionally, the SGi reference point between the PGW 232 and the data network 2 36 may be an operator external public, a private PDN, or an intra-operator packet data network, for example, for provision of IMS services. The PGW 232 may be coupled with a PCRF 234 via a Gx reference point.

The PCRF 234 is the policy and charging control element of the LTE CN 222. The PCRF 234 may be communicatively coupled to the app/content server 238 to determine appropriate QoS and charging parameters for service flows. The PCRF 232 may provision associated rules into a PCEF (via Gx reference point) with appropriate TFT and QCI.

In some embodiments, the CN 220 may be a 5GC 240. The 5GC 240 may include an AUSF 242, AMF 244, SMF 246, UPF 248, NSSF 250, NEF 252, NRF 254, PCF 256, UDM 258, and AF 260 coupled with one another over interfaces (or “reference points”) as shown. Functions of the elements of the 5GC 240 may be briefly introduced as follows.

The AUSF 242 may store data for authentication of UE 202 and handle authentication-related functionality. The AUSF 242 may facilitate a common authentication framework for various access types. In addition to communicating with other elements of the 5GC 240 over reference points as shown, the AUSF 242 may exhibit an Nausf service-based interface.

The AMF 244 may allow other functions of the 5GC 240 to communicate with the UE 202 and the RAN 204 and to subscribe to notifications about mobility events with respect to the UE 202. The AMF 244 may be responsible for registration management (for example, for registering UE 202), connection management, reachability management, mobility management, lawful interception of AMF-related events, and access authentication and authorization. The AMF 244 may provide transport for SM messages between the UE 202 and the SMF 246, and act as a transparent proxy for routing SM messages. AMF 244 may also provide transport for SMS messages between UE 202 and an SMSF. AMF 244 may interact with the AUSF 242 and the UE 202 to perform various security anchor and context management functions. Furthermore, AMF 244 may be a termination point of a RAN CP interface, which may include or be an N2 reference point between the RAN 204 and the AMF 244; and the AMF 244 may be a termination point of NAS (N1) signaling, and perform NAS ciphering and integrity protection. AMF 244 may also support NAS signaling with the UE 202 over an N3 IWF interface.

The SMF 246 may be responsible for SM (for example, session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 244 over N2 to AN 208; and determining SSC mode of a session. SM may refer to management of a PDU session, and a PDU session or “session” may refer to a PDU connectivity service that provides or enables the exchange of PDUs between the UE 202 and the data network 236.

The UPF 248 may act as an anchor point for intra-RAT and inter-RAT mobility, an external PDU session point of interconnect to data network 236, and a branching point to support multi-homed PDU session. The UPF 248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 248 may include an uplink classifier to support routing traffic flows to a data network.

The NSSF 250 may select a set of network slice instances serving the UE 202. The NSSF 250 may also determine allowed NSSAI and the mapping to the subscribed S-NSSAIs, if needed. The NSSF 250 may also determine the AMF set to be used to serve the UE 202, or a list of candidate AMFs based on a suitable configuration and possibly by querying the NRF 254. The selection of a set of network slice instances for the UE 202 may be triggered by the AMF 244 with which the UE 202 is registered by interacting with the NSSF 250, which may lead to a change of AMF. The NSSF 250 may interact with the AMF 244 via an N22 reference point; and may communicate with another NSSF in a visited network via an N31 reference point (not shown). Additionally, the NSSF 250 may exhibit an Nnssf service-based interface.

The NEF 252 may securely expose services and capabilities provided by 3GPP network functions for third party, internal exposure/re-exposure, AFs (e.g., AF 260), edge computing or fog computing systems, etc. In such embodiments, the NEF 252 may authenticate, authorize, or throttle the AFs. NEF 252 may also translate information exchanged with the AF 260 and information exchanged with internal network functions. For example, the NEF 252 may translate between an AF-Service-Identifier and an internal 5GC information. NEF 252 may also receive information from other NFs based on exposed capabilities of other NFs. This information may be stored at the NEF 252 as structured data, or at a data storage NF using standardized interfaces. The stored information can then be re-exposed by the NEF 252 to other NFs and AFs, or used for other purposes such as analytics. Additionally, the NEF 252 may exhibit an Nnef service-based interface.

The NRF 254 may support service discovery functions, receive NF discovery requests from NF instances, and provide the information of the discovered NF instances to the NF instances. NRF 254 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 254 may exhibit the Nnrf service-based interface.

The PCF 256 may provide policy rules to control plane functions to enforce them, and may also support unified policy framework to govern network behavior. The PCF 256 may also implement a front end to access subscription information relevant for policy decisions in a UDR of the UDM 258. In addition to communicating with functions over reference points as shown, the PCF 256 exhibit an Npcf service-based interface.

The UDM 258 may handle subscription-related information to support the network entities' handling of communication sessions, and may store subscription data of UE 202. For example, subscription data may be communicated via an N8 reference point between the UDM 258 and the AMF 244. The UDM 258 may include two parts, an application front end and a UDR. The UDR may store subscription data and policy data for the UDM 258 and the PCF 256, and/or structured data for exposure and application data (including PFDs for application detection, application request information for multiple UEs 202) for the NEF 252. The Nudr service-based interface may be exhibited by the UDR 221 to allow the UDM 258, PCF 256, and NEF 252 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 258 may exhibit the Nudm service-based interface.

The AF 260 may provide application influence on traffic routing, provide access to NEF, and interact with the policy framework for policy control.

In some embodiments, the 5GC 240 may enable edge computing by selecting operator/3^{rd} party services to be geographically close to a point that the UE 202 is attached to the network. This may reduce latency and load on the network. To provide edge-computing implementations, the 5GC 240 may select a UPF 248 close to the UE 202 and execute traffic steering from the UPF 248 to data network 236 via the N6 interface. This may be based on the UE subscription data, UE location, and information provided by the AF 260. In this way, the AF 260 may influence UPF (re)selection and traffic routing. Based on operator deployment, when AF 260 is considered to be a trusted entity, the network operator may permit AF 260 to interact directly with relevant NFs. Additionally, the AF 260 may exhibit an Naf service-based interface.

The data network 236 may represent various network operator services, Internet access, or third party services that may be provided by one or more servers including, for example, application/content server 238.

FIG. 3 schematically illustrates a wireless network 300 in accordance with various embodiments. The wireless network 300 may include a UE 302 in wireless communication with an AN 304. The UE 302 and AN 304 may be similar to, and substantially interchangeable with, like-named components described elsewhere herein.

The UE 302 may be communicatively coupled with the AN 304 via connection 306. The connection 306 is illustrated as an air interface to enable communicative coupling, and can be consistent with cellular communications protocols such as an LTE protocol or a 5G NR protocol operating at mmWave or sub-6 GHz frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example UDP) and Internet (for example, IP) operations

The protocol processing circuitry 314 may implement one or more of layer operations to facilitate transmission or reception of data over the connection 306. The layer operations implemented by the protocol processing circuitry 314 may include, for example, MAC, RLC, PDCP, RRC and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318, receive circuitry 320, RF circuitry 322, RFFE 324, and antenna panels 326 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 314 may include one or more instances of control circuitry (not shown) to provide control functions for the transmit/receive components.

A UE reception may be established by and via the antenna panels 326, RFFE 324, RF circuitry 322, receive circuitry 320, digital baseband circuitry 316, and protocol processing circuitry 314. In some embodiments, the antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and antenna panels 326. In some embodiments, the transmit components of the UE 304 may apply a spatial filter to the data to be transmitted to form a transmit beam emitted by the antenna elements of the antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with like-named components of the UE 302. In addition to performing data transmission/reception as described above, the components of the AN 308 may perform various logical functions that include, for example, RNC functions such as radio bearer management, uplink and downlink dynamic radio resource management, and data packet scheduling.

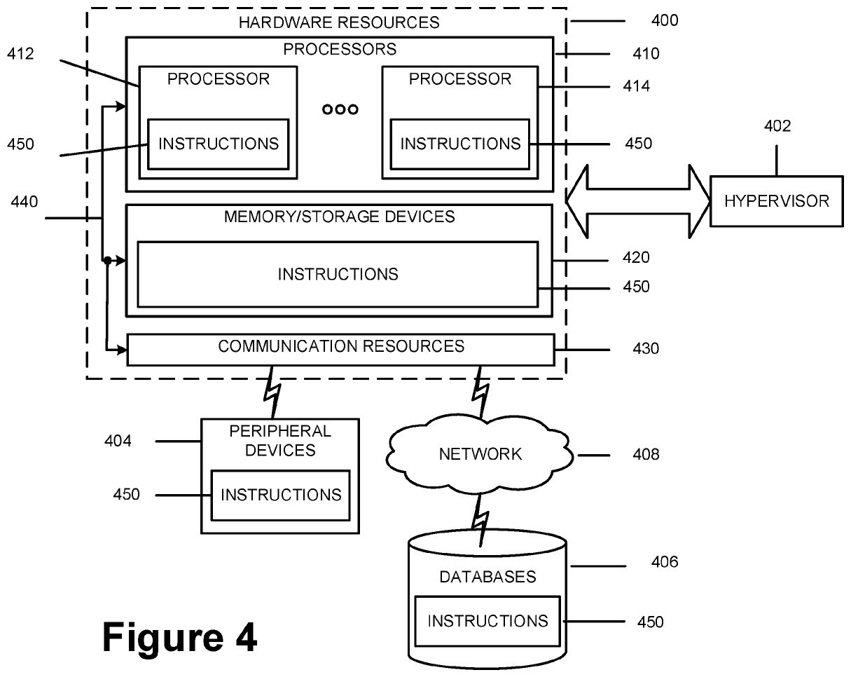

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400 including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The processors 410 may include, for example, a processor 412 and a processor 414. The processors 410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include main memory, disk storage, or any suitable combination thereof. The memory/storage devices 420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 430 may include interconnection or network interface controllers, components, or other suitable devices to communicate with one or more peripheral devices 404 or one or more databases 406 or other network elements via a network 408. For example, the communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the processors 410 to perform any one or more of the methodologies discussed herein. The instructions 450 may reside, completely or partially, within at least one of the processors 410 (e.g., within the processor's cache memory), the memory/storage devices 420, or any suitable combination thereof. Furthermore, any portion of the instructions 450 may be transferred to the hardware resources 400 from any combination of the peripheral devices 404 or the databases 406. Accordingly, the memory of processors 410, the memory/storage devices 420, the peripheral devices 404, and the databases 406 are examples of computer-readable and machine-readable media.

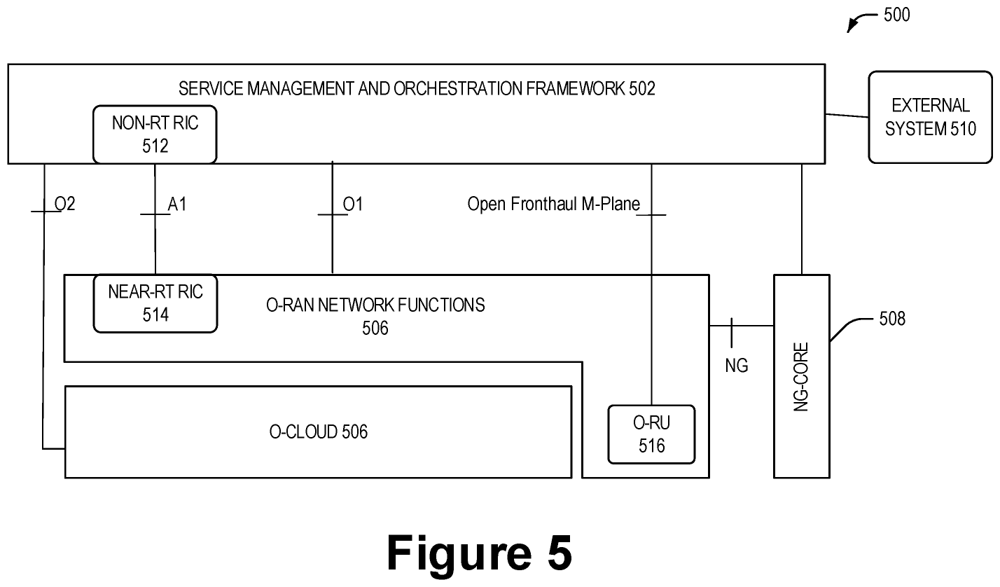

FIG. 5 provides a high-level view of an Open RAN (O-RAN) architecture 500. The O-RAN architecture 500 includes four O-RAN defined interfaces—namely, the A1 interface, the O1 interface, the O2 interface, and the Open Fronthaul Management (M)-plane interface—which connect the Service Management and Orchestration (SMO) framework 502 to O-RAN network functions (NFs) 504 and the O-Cloud 506. The SMO 502 (described in [O13]) also connects with an external system 510, which provides enrighment data to the SMO 502. FIG. 5 also illustrates that the A1 interface terminates at an O-RAN Non-Real Time (RT) RAN Intelligent Controller (RIC) 512 in or at the SMO 502 and at the O-RAN Near-RT RIC 514 in or at the O-RAN NFs 504. The O-RAN NFs 504 can be VNFs such as VMs or containers, sitting above the O-Cloud 506 and/or Physical Network Functions (PNFs) utilizing customized hardware. All O-RAN NFs 504 are expected to support the O1 interface when interfacing the SMO framework 502. The O-RAN NFs 504 connect to the NG-Core 508 via the NG interface (which is a 3GPP defined interface). The Open Fronthaul M-plane interface between the SMO 502 and the O-RAN Radio Unit (O-RU) 516 supports the O-RU 516 management in the O-RAN hybrid model as specified in [O16]. The Open Fronthaul M-plane interface is an optional interface to the SMO 502 that is included for backward compatibility purposes as per [O16], and is intended for management of the O-RU 516 in hybrid mode only. The management architecture of flat mode [O12] and its relation to the O1 interface for the O-RU 516 is for future study. The O-RU 516 termination of the O1 interface towards the SMO 502 as specified in [O12].

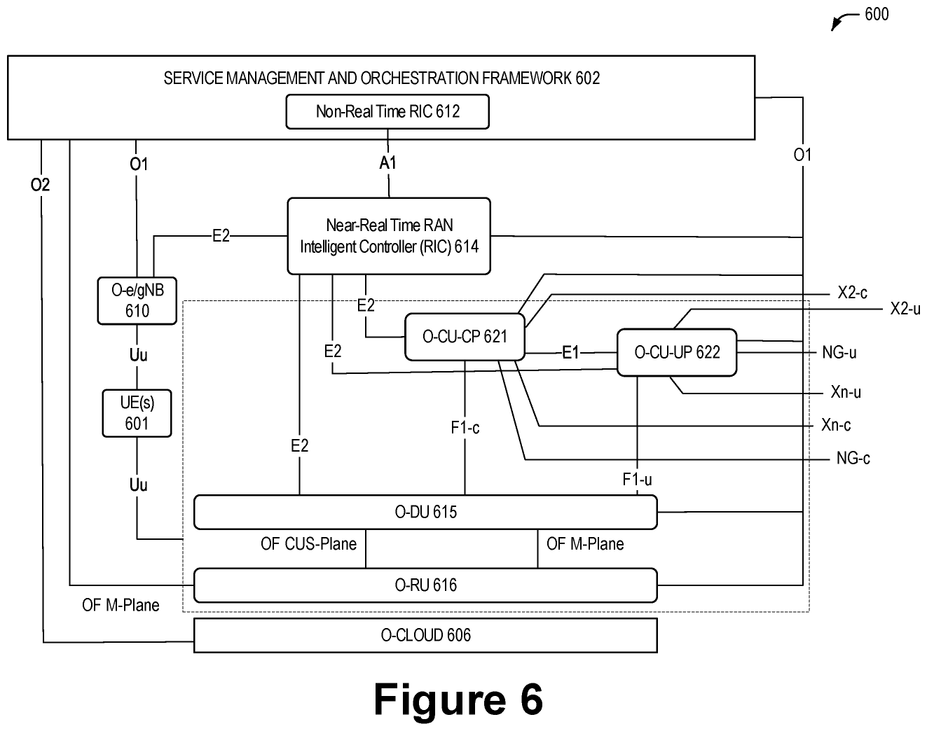

FIG. 6 shows an O-RAN logical architecture 600 corresponding to the O-RAN architecture 500 of FIG. 5. In FIG. 6, the SMO 602 corresponds to the SMO 502, O-Cloud 606 corresponds to the O-Cloud 506, the non-RT RIC 612 corresponds to the non-RT RIC 512, the near-RT RIC 614 corresponds to the near-RT RIC 514, and the O-RU 616 corresponds to the O-RU 516 of FIG. 6, respectively. The O-RAN logical architecture 600 includes a radio portion and a management portion.

The management portion/side of the architectures 600 includes the SMO Framework 602 containing the non-RT RIC 612, and may include the O-Cloud 606. The O-Cloud 606 is a cloud computing platform including a collection of physical infrastructure nodes to host the relevant O-RAN functions (e.g., the near-RT RIC 614, O-CU-CP 621, O-CU-UP 622, and the O-DU 615), supporting software components (e.g., OSs, VMMs, container runtime engines, ML engines, etc.), and appropriate management and orchestration functions.

The radio portion/side of the logical architecture 600 includes the near-RT RIC 614, the O-RAN Distributed Unit (O-DU) 615, the O-RU 616, the O-RAN Central Unit—Control Plane (O-CU-CP) 621, and the O-RAN Central Unit—User Plane (O-CU-UP) 622 functions. The radio portion/side of the logical architecture 600 may also include the O-e/gNB 610.

The O-DU 615 is a logical node hosting RLC, MAC, and higher PHY layer entities/elements (High-PHY layers) based on a lower layer functional split. The O-RU 616 is a logical node hosting lower PHY layer entities/elements (Low-PHY layer) (e.g., FFT/iFFT, PRACH extraction, etc.) and RF processing elements based on a lower layer functional split. Virtualization of O-RU 616 is FFS. The O-CU-CP 621 is a logical node hosting the RRC and the control plane (CP) part of the PDCP protocol. The O O-CU-UP 622 is a a logical node hosting the user plane part of the PDCP protocol and the SDAP protocol.

An E2 interface terminates at a plurality of E2 nodes. The E2 nodes are logical nodes/entities that terminate the E2 interface. For NR/5G access, the E2 nodes include the O-CU-CP 621, O-CU-UP 622, O-DU 615, or any combination of elements as defined in [O15]. For E-UTRA access the E2 nodes include the O-e/gNB 610. As shown in FIG. 6, the E2 interface also connects the O-e/gNB 610 to the Near-RT RIC 614. The protocols over E2 interface are based exclusively on Control Plane (CP) protocols. The E2 functions are grouped into the following categories: (a) near-RT RIC 614 services (REPORT, INSERT, CONTROL and POLICY, as described in [O15]); and (b) near-RT RIC 614 support functions, which include E2 Interface Management (E2 Setup, E2 Reset, Reporting of General Error Situations, etc.) and Near-RT RIC Service Update (e.g., capability exchange related to the list of E2 Node functions exposed over E2).

FIG. 6 shows the Uu interface between a UE 601 and O-e/gNB 610 as well as between the UE 601 and O-RAN components. The Uu interface is a 3GPP defined interface (see e.g., sections 5.2 and 5.3 of [O07]), which includes a complete protocol stack from L1 to L3 and terminates in the NG-RAN or E-UTRAN. The O-e/gNB 610 is an LTE eNB [O04], a 5G gNB or ng-eNB [O06] that supports the E2 interface. The O-e/gNB 610 may be the same or similar as other gNBs discussed previously. The a UE 601 may correspond to UEs discussed previously. There may be multiple UEs 601 and/or multiple O-e/gNB 610, each of which may be connected to one another the via respective Uu interfaces. Although not shown in FIG. 6, the O-e/gNB 610 supports O-DU 615 and O-RU 616 functions with an Open Fronthaul interface between them.

The Open Fronthaul (OF) interface(s) is/are between O-DU 615 and O-RU 616 functions [O16] [O17]. The OF interface(s) includes the Control User Synchronization (CUS) Plane and Management (M) Plane. FIGS. 5 and 6 also show that the O-RU 616 terminates the OF M-Plane interface towards the O-DU 615 and optionally towards the SMO 602 as specified in [O16]. The O-RU 616 terminates the OF CUS-Plane interface towards the O-DU 615 and the SMO 602.

The F1-c interface connects the O-CU-CP 621 with the O-DU 615. As defined by 3GPP, the F1-c interface is between the gNB-CU-CP and gNB-DU nodes [O07] [O10]. However, for purposes of O-RAN, the F1-c interface is adopted between the O-CU-CP 621 with the O-DU 615 functions while reusing the principles and protocol stack defined by 3GPP and the definition of interoperability profile specifications.

The F1-u interface connects the O-CU-UP 622 with the O-DU 615. As defined by 3GPP, the F1-u interface is between the gNB-CU-UP and gNB-DU nodes [O07] [O10]. However, for purposes of O-RAN, the F1-u interface is adopted between the O-CU-UP 622 with the O-DU 615 functions while reusing the principles and protocol stack defined by 3GPP and the definition of interoperability profile specifications.

The NG-c interface is defined by 3GPP as an interface between the gNB-CU-CP and the AMF in the 5GC [O06]. The NG-c is also referred as the N2 interface (see [O06]). The NG-u interface is defined by 3GPP, as an interface between the gNB-CU-UP and the UPF in the 5GC [O06]. The NG-u interface is referred as the N3 interface (see [O06]). In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC (see e.g., [O05], [O06]). In O-RAN, X2-c and X2-u protocol stacks defined by 3GPP are reused and may be adapted for O-RAN purposes

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB (see e.g., [O06], [O08]). In O-RAN, Xn-c and Xn-u protocol stacks defined by 3GPP are reused and may be adapted for O-RAN purposes

The E1 interface is defined by 3GPP as being an interface between the gNB-CU-CP (e.g., gNB-CU-CP 3728) and gNB-CU-UP (see e.g., [O07], [O09]). In O-RAN, E1 protocol stacks defined by 3GPP are reused and adapted as being an interface between the O-CU-CP 621 and the O-CU-UP 622 functions.

The O-RAN Non-Real Time (RT) RAN Intelligent Controller (RIC) 612 is a logical function within the SMO framework 502, 602 that enables non-real-time control and optimization of RAN elements and resources; AI/machine learning (ML) workflow(s) including model training, inferences, and updates; and policy-based guidance of applications/features in the Near-RT RIC 614.

The O-RAN near-RT RIC 614 is a logical function that enables near-real-time control and optimization of RAN elements and resources via fine-grained data collection and actions over the E2 interface. The near-RT RIC 614 may include one or more AI/ML workflows including model training, inferences, and updates.

The non-RT RIC 612 can be an ML training host to host the training of one or more ML models. ML training can be performed offline using data collected from the RIC, O-DU 615 and O-RU 616. For supervised learning, non-RT RIC 612 is part of the SMO 602, and the ML training host and/or ML model host/actor can be part of the non-RT RIC 612 and/or the near-RT RIC 614. For unsupervised learning, the ML training host and ML model host/actor can be part of the non-RT RIC 612 and/or the near-RT RIC 614. For reinforcement learning, the ML training host and ML model host/actor may be co-located as part of the non-RT RIC 612 and/or the near-RT RIC 614. In some implementations, the non-RT RIC 612 may request or trigger ML model training in the training hosts regardless of where the model is deployed and executed. ML models may be trained and not currently deployed.

In some implementations, the non-RT RIC 612 provides a query-able catalog for an ML designer/developer to publish/install trained ML models (e.g., executable software components). In these implementations, the non-RT RIC 612 may provide discovery mechanism if a particular ML model can be executed in a target ML inference host (MF), and what number and type of ML models can be executed in the MF. For example, there may be three types of ML catalogs made disoverable by the non-RT RIC 612: a design-time catalog (e.g., residing outside the non-RT RIC 612 and hosted by some other ML platform(s)), a training/deployment-time catalog (e.g., residing inside the non-RT RIC 612), and a run-time catalog (e.g., residing inside the non-RT RIC 612). The non-RT RIC 612 supports necessary capabilities for ML model inference in support of ML assisted solutions running in the non-RT RIC 612 or some other ML inference host. These capabilities enable executable software to be installed such as VMs, containers, etc. The non-RT RIC 612 may also include and/or operate one or more ML engines, which are packaged software executable libraries that provide methods, routines, data types, etc., used to run ML models. The non-RT RIC 612 may also implement policies to switch and activate ML model instances under different operating conditions.

The non-RT RIC 62 is be able to access feedback data (e.g., FM and PM statistics) over the O1 interface on ML model performance and perform necessary evaluations. If the ML model fails during runtime, an alarm can be generated as feedback to the non-RT RIC 612. How well the ML model is performing in terms of prediction accuracy or other operating statistics it produces can also be sent to the non-RT RIC 612 over O1. The non-RT RIC 612 can also scale ML model instances running in a target MF over the O1 interface by observing resource utilization in MF. The environment where the ML model instance is running (e.g., the MF) monitors resource utilization of the running ML model. This can be done, for example, using an ORAN-SC component called ResourceMonitor in the near-RT RIC 614 and/or in the non-RT RIC 612, which continuously monitors resource utilization. If resources are low or fall below a certain threshold, the runtime environment in the near-RT RIC 614 and/or the non-RT RIC 612 provides a scaling mechanism to add more ML instances. The scaling mechanism may include a scaling factor such as an number, percentage, and/or other like data used to scale up/down the number of ML instances. ML model instances running in the target ML inference hosts may be automatically scaled by observing resource utilization in the MF. For example, the Kubernetes® (K8s) runtime environment typically provides an auto-scaling feature.

The A1 interface is between the non-RT RIC 612 (within or outside the SMO 602) and the near-RT RIC 614. The A1 interface supports three types of services as defined in [O14], including a Policy Management Service, an Enrichment Information Service, and ML Model Management Service. A1 policies have the following characteristics compared to persistent configuration [O14]: A1 policies are not critical to traffic; A1 policies have temporary validity; A1 policies may handle individual UE or dynamically defined groups of UEs; A1 policies act within and take precedence over the configuration; and A1 policies are non-persistent, e.g., do not survive a restart of the near-RT RIC.

3GPP TS 38.470 v16.0.0 (2020 Jan. 9).

O-RAN Alliance Working Group 1, 0-RAN Operations and Maintenance Architecture Specification, version 2.0 (December 2019) (“O-RAN-WG1.OAM-Architecture-v02.00”).

O-RAN Alliance Working Group 1, 0-RAN Operations and Maintenance Interface Specification, version 2.0 (December 2019) (“O-RAN-WG1.O1-Interface-v02.00”).

O-RAN Alliance Working Group 2, 0-RAN A1 interface: General Aspects and Principles Specification, version 1.0 (October 2019) (“ORAN-WG2.A1.GA&P-v01.00”).

O-RAN Alliance Working Group 3, Near-Real-time RAN Intelligent Controller Architecture & E2 General Aspects and Principles (“ORAN-WG3.E2GAP.0-v0.1”).

O-RAN Alliance Working Group 4, 0-RAN Fronthaul Management Plane Specification, version 2.0 (July 2019) (“ORAN-WG4.MP.0-v02.00.00”).

O-RAN Alliance Working Group 4, 0-RAN Fronthaul Control, User and Synchronization Plane Specification, version 2.0 (July 2019) (“ORAN-WG4.CUS.0-v02.00”).

### Example Procedures

In some embodiments, the electronic device(s), network(s), system(s), chip(s) or component(s), or portions or implementations thereof, of FIGS. 2-4, or some other figure herein, may be configured to perform one or more processes, techniques, or methods as described herein, or portions thereof.

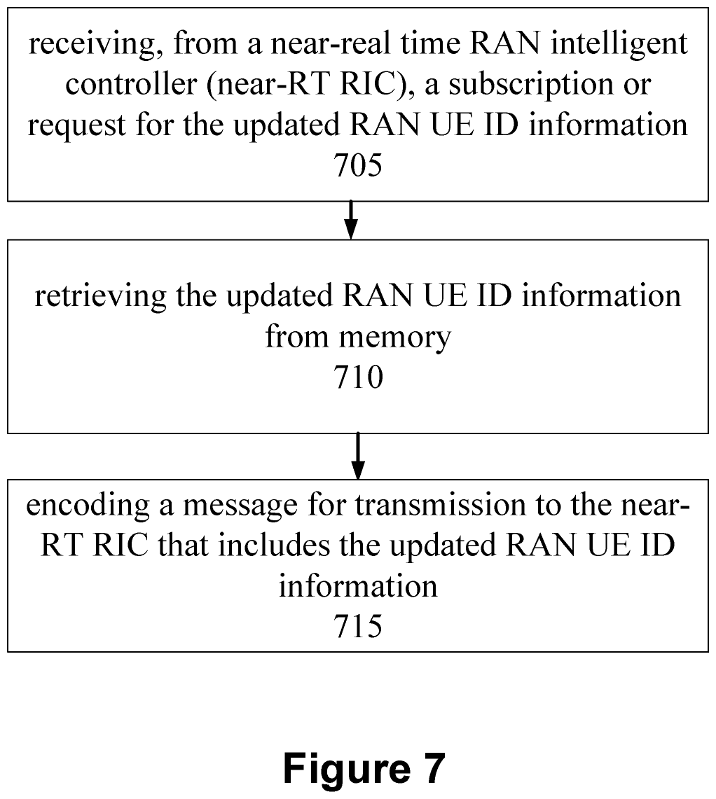

One such process is depicted in FIG. 7. In some embodiments, the process of FIG. 7 may be performed by a gNB or a portion thereof. For example, the process may include, at 705, receiving, from a near-real time RAN intelligent controller (near-RT RIC), a subscription or request for the updated RAN UE ID information. The process further includes, at 710, retrieving the updated RAN UE ID information from memory. The process further includes, at 715, encoding a message for transmission to the near-RT RIC that includes the updated RAN UE ID information.

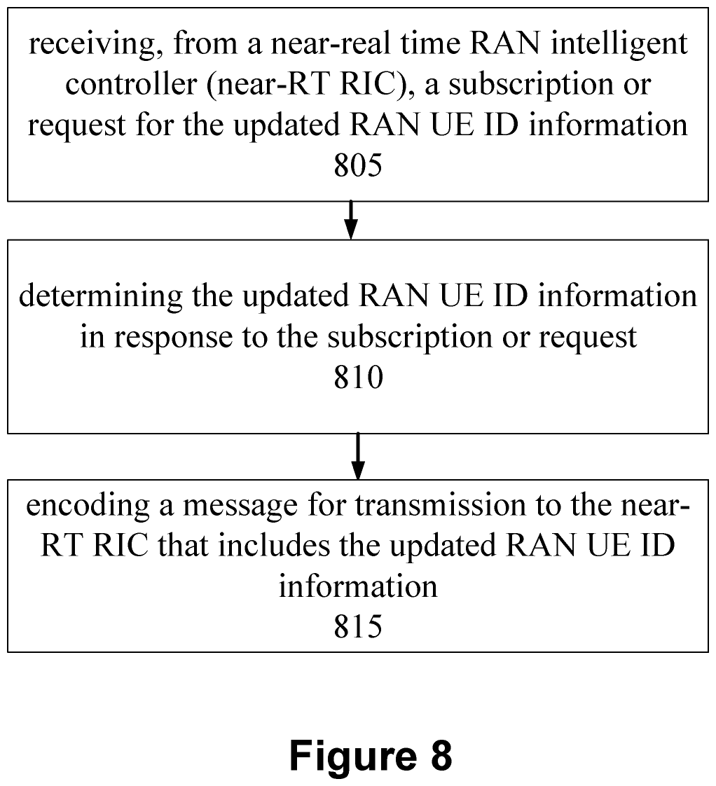

Another such process is depicted in FIG. 8. In some embodiments, the process of FIG. 8 may be performed by a gNB or a portion thereof. For example, the process may include, at 805, receiving, from a near-real time RAN intelligent controller (near-RT RIC), a subscription or request for the updated RAN UE ID information. The process further includes, at 810, determining the updated RAN UE ID information in response to the subscription or request. The process further includes, at 815, encoding a message for transmission to the near-RT RIC that includes the updated RAN UE ID information.

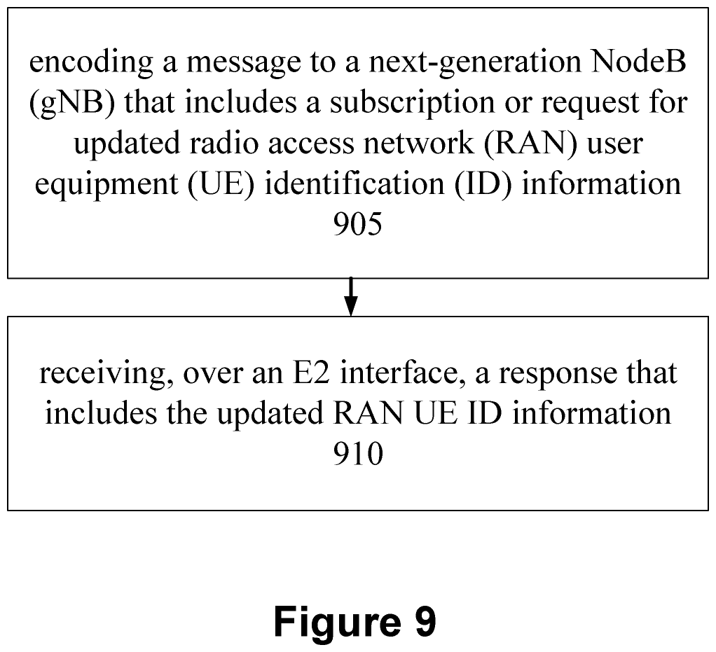

Another such process is depicted in FIG. 9, which may be performed by a near-real time RAN intelligent controller (near-RT RIC) in some embodiments. In this example, the process includes, at 905, encoding a message to a next-generation NodeB (gNB) that includes a subscription or request for updated radio access network (RAN) user equipment (UE) identification (ID) information. The process further includes, at 910, receiving, over an E2 interface, a response that includes the updated RAN UE ID information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include an apparatus in O-RAN comprising:
RAN nodes, employed as eNodeB or next generation NodeB in SGS; or employed as a CU (centralized unit) and a DU (distributed unit) inter-connected via F1 interface, for which CU may be further split into control plane (CU-CP) and user plane (CU-UP) inter-connected via E1 interface.
The near real-time (Near-RT) RAN intelligence controller (RIC) for the optimized controls over RAN nodes over E2 interface.
Means to support the RAN UE ID based UE identification across O1/A1/E2 interfaces

Example 2 may include near-RT RIC subscribes or requests an update of a RAN UE ID (whenever (re/de)assigned) of the UEs from a RAN node over E2 interface, according to UE group/categories of interest.

Example 3 may include RAN UE ID of a UE updated to O-RAN includes node IDs of the corresponding DU and CU-UP that are serving the UE, in case of CU-DU split or CP-UP separated.

Example X1 includes an apparatus comprising: memory to store updated radio access network (RAN) user equipment (UE) identification (ID) information; and processing circuitry, coupled with the memory, to: receive, from a near-real time RAN intelligent controller (near-RT RIC), a subscription or request for the updated RAN UE ID information; retrieve the updated RAN UE ID information from the memory; and encode a message for transmission to the near-RT RIC that includes the updated RAN UE ID information.

Example X2 includes the apparatus of example X1 or some other example herein, wherein the updated RAN UE ID information is represented by an octet string.

Example X3 includes the apparatus of example X2 or some other example herein, wherein the octet string has a size of eight characters.

Example X4 includes the apparatus of any of examples X1-X3, wherein the message is encoded for transmission via an E2 interface.

Example X5 includes the apparatus of any of examples X1-X4, wherein the subscription or request is received via an E2 interface.

Example X6 includes the apparatus of any of examples X1-X5, wherein the apparatus comprises a next-generation NodeB (gNB) implementing a control unit-control plane (CU-CP).

Example X7 includes the apparatus of example X6, wherein the gNB further implements a distributed unit (DU) and a control unit-user plane (CU-UP).

Example X8 includes one or more computer-readable media storing instructions that, when executed by one or more processors, cause a next-generation NodeB (gNB) to: receive, from a near-real time RAN intelligent controller (near-RT RIC), a subscription or request for updated radio access network (RAN) user equipment (UE) identification (ID) information; determine the updated RAN UE ID information in response to the subscription or request; and encode a message for transmission to the near-RT RIC that includes the updated RAN UE ID information.

Example X9 includes the one or more computer-readable media of example X8 or some other example herein, wherein the updated RAN UE ID information is represented by an octet string.

Example X10 includes the one or more computer-readable media of example X9 or some other example herein, wherein the octet string has a size of eight characters.

Example X11 includes the one or more computer-readable media of any of examples X8-X10, wherein the message is encoded for transmission via an E2 interface.

Example X12 includes the one or more computer-readable media of any of examples X8-X11, wherein the subscription or request is received via an E2 interface.

Example X13 includes the one or more computer-readable media of any of examples X8-X12, wherein the gNB implements a control unit-control plane (CU-CP).

Example X14 includes the one or more computer-readable media of X13 or some other example herein, wherein the gNB further implements a distributed unit (DU) and a control unit-user plane (CU-UP).

Example X15 includes one or more computer-readable media storing instructions that, when executed by one or more processors, cause a near-real time RAN intelligent controller (near-RT RIC) to: encode a message to a next-generation NodeB (gNB) that includes a subscription or request for updated radio access network (RAN) user equipment (UE) identification (ID) information; and receive, over an E2 interface, a response that includes the updated RAN UE ID information.

Example X16 includes the one or more computer-readable media of example X15 or some other example herein, wherein the updated RAN UE ID information is represented by an octet string.

Example X17 includes the one or more computer-readable media of example X16 or some other example herein, wherein the octet string has a size of eight characters.

Example X18 includes the one or more computer-readable media of any of examples X15-X17, wherein the message is encoded for transmission via an E2 interface.

Example X19 includes the one or more computer-readable media of any of examples X15-X18, wherein the message is directed to a control unit-control plane (CU-CP) implemented by the gNB.

Example Z01 may include an apparatus comprising means to perform one or more elements of a method described in or related to any of examples 1-X19, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-X19, or any other method or process described herein.

Example Z03 may include an apparatus comprising logic, modules, or circuitry to perform one or more elements of a method described in or related to any of examples 1-X19, or any other method or process described herein.

Example Z04 may include a method, technique, or process as described in or related to any of examples 1-X19, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-X19, or portions thereof.

Example Z06 may include a signal as described in or related to any of examples 1-X19, or portions or parts thereof.

Example Z07 may include a datagram, packet, frame, segment, protocol data unit (PDU), or message as described in or related to any of examples 1-X19, or portions or parts thereof, or otherwise described in the present disclosure.

Example Z08 may include a signal encoded with data as described in or related to any of examples 1-X19, or portions or parts thereof, or otherwise described in the present disclosure.

Example Z09 may include a signal encoded with a datagram, packet, frame, segment, protocol data unit (PDU), or message as described in or related to any of examples 1-X19, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-X19, or portions thereof.

Example Z11 may include a computer program comprising instructions, wherein execution of the program by a processing element is to cause the processing element to carry out the method, techniques, or process as described in or related to any of examples 1-X19, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | | | | |
|---|---|---|---|---|---|
| 3 GPP | Third Generation | ASN.1 | Abstract Syntax | CAPEX | CAPital |
| | Partnership | | Notation One | | EXpenditure |
| | Project | AUSF | Authentication | CBRA | Contention Based |
| 4 G | Fourth Generation | | Server Function | | Random Access |
| 5 G | Fifth Generation | AWGN | Additive | CC | Component |
| 5 GC | 5 G Core network | | White Gaussian | | Carrier, Country |
| ACK | Acknowledgement | BAP | Backhaul | | Checksum |
| | | | Adaption Protocol | CCA | Clear Channel |
| AF | Application | BCH | Broadcast | | Assessment |
| | Function | | Channel | CCE | Control Channel |
| AM | Acknowledged | BER | Bit Error Ratio | | Element |
| | Mode | BFD | Beam Failure | CCCH | Common Control |
| AMBR | Aggregate | | Detection | | Channel |
| | Maximum Bit Rate | BLER | Block Error Rate | CE | Coverage |
| AMF | Access and | BPSK | Binary Phase Shift | | Enhancement |
| | Mobility | | Keying | CDM | Content Delivery |
| | Management | | BRAS Broadband | | Network |
| | Function | | Remote Access | CDMA | Code-Division |
| AN | Access Network | | Server | | Multiple Access |
| ANR | Automatic | BBS | Business Suppport | | |
| | Neighbour Relation | | System | CFRA | Contention Free |
| AP | Application | BS | Base Station | | Random Access |
| | Protocol, Antenna | BSR | Buffer Status | CG | Cell Group |
| | Port, Access Point | | Report | CI | Cell Identity |
| API | Application | BW | Bandwidth | CID | Cell-ID (e.g., |
| | Programming | BWP | Bandwidth Part | | positioning method) |
| | Interface | | | | |
| APN | Access Point | C-RNTI | Cell Radio | CIM | Common |
| | Name | | Network Temporary | | Information Model |
| ARP | Allocation and | | Identity | CIR | Carrier to |
| | Retention Priority | CA | Carrier Aggregation, | | Interface Ratio |
| ARQ | Automatic Repeat | | Certification | CK | Cipher Key |
| | Request | | Authority | CM | Connection |
| AS | Access Stratum | CRAN | Cloud Radio | | Management, |
| | Conditional | | Access Network, | CSMA/CA | CSMA with |
| | Mandatory | | Cloud RAN | | collision avoidance |
| CMAS | Commercial | CRB | Common | CSS | Common Search |
| | Mobile Alert Service | | Resource Block | | Space, Cell-specific |
| CMD | Command | CRC | Cyclic | | Search Space |
| CMS | Cloud | | Redundancy Check | CTS | Clear-to-Send |
| | Management System | | | CW | Codeword |
| CO | Conditional | CRI | Channel-State | CWS | Contention |
| | Optional | | Information Resource | | Window Size |
| CoMP | Coordinated | | Indicator, CSI-RS | | D2D Device-to- |
| | Multi-Point | | Resource Indicator | | Device |
| CORSET | Control | C-RNTI | Cell RNTI | DC | Dual Connectivity, |
| | Resource Set | CS | Circuit Switched | | Direct Current |
| COTS | Commercial Off- | CSAR | Cloud Service | DCI | Downlink Control |
| | The-Shelf | | Archive | | Information |
| CP | Control Plane, | CSI | Channel-State | DF | Deployment |
| | Cyclic Prefix, | | Information | | Flavour |
| | Connection Point | | | DL | Downlink |
| CPD | Connection Point | CSI-IM | CSI Interference | DMTF | Distributed |
| | Descriptor | | Measurement | | Management |
| CPE | Customer Premise | CSI-RS | CSI | | Task Force |
| | Equipment | | Reference Signal | DPDK | Data Plane |
| CPICH | Common Pilot | CSI- | CSI | | Development Kit |
| | Channel | RSRP | reference signal | DM-RS, | Demodulation |
| CQI | Channel Quality | | received power | | Reference Signal |
| | Indicator | CSI- | CSI reference signal | DN | Data network |
| CPU | CSI proceessing | RSRQ | received quality | DRS | Discovery |
| | unit, Central | CSI- | CSI signal-to-noise | | Reference Signal |
| | Processing Unit | SINR | and interference ratio | DRX | Discontinuous |
| C/R | Command/Response | | | | Reception |
| | field bit | | | DSL | Domain Specific |
| DSLAM | DSL Access | CSMA | Carrier Sense | | Language. Digital |
| | Multiplexer | | Multiple Access | | Subscriber Line |
| DwPTS | Downlink | EMS | Element Management | E-UTRAN | Evolved UTRAN |
| | Pilot Time Slot | | System | EV2X | Enhanced V2X |
| E-LAN | Ethernet | eNB | evolved NodeB, | F1AP | F1 Application |
| | Local Area Network | E-UTRAN | Node B | | Protocol |
| E2E | End-to-End | NR Dual | Connectivity | F1-C | F1 Control plane |
| ECCA | Extended clear | EPC | Evolved Packet | | interface |
| | channel assessment, | | Core | F1-U | F1 User plane interface |
| | extended CCA | EPDCCH | enhanced | FACCH | Fast Associated Control |
| ECCE | Enhanced Control | PDCCH | enhanced Physcial | | CHannel |
| | Channel Element, | | Downlink Control | FACCH/F | Fast Associated Control |
| | Enhanced CCE | | Channel | | Channel/Full rate |
| ED | Energey Detection | EPRE | Energy per resource | FACCH/H | Fast Associated Control |
| EDGE | Enhanced Datarates | | element | | Channel/Half rate |
| | for GSM Evolution | EPS | Evolved Packet | FACH | Forward Access |
| | (GSM Evolution) | | System | | Channel |
| EGMF | Exposure | EREG | enhanced REG, | FAUSH | Fast Uplink Signalling |
| | Governance | | resource element | | Channel |
| | Management Function | ETSI | European | FB | Functional Book |
| EGPRS | Enhanced GPRS | | Telecommunications | FBI | Feedback Information |
| EIR | Equipment | | Standards Institute | FCC | Federal Communications |
| | Identity Register | ETWS | Earthquake and | | Commission |
| eLAA | enhanced Licensed | | Tsunami Warning | FCCH | Frequency Correction |
| | Assisted Access, | | System | | CHannel |
| | enhanced | eUICC | embedded UICC, | FDD | Frequency Division |
| LAAEM | Element Manager | | embedded Universal | | Duplex |
| eMBB | Enhanced Mobile | | Integrated Circuit | GUTI | Globally Unique |
| | Broadbandd | | card | | Temporary UE |
| FDM | Frequency | E-UTRA | Evolved UTRA | | Identity |
| | Divison Multiplex | | Sputnikovaya | HARQ | Hybrid ARQ, |
| FDMA | Frequency | | Sistema (Engl.: | | Hybrid Automatic |
| | Division Multiple | | Global Navigation | | Repeat Request |
| | Access | | Satellite System) | HANDO | Handover |
| FE | Front End | gNB | Next Generation | HFN | HyperFrame |
| FEC | Forward Error | NodeB | gNB-centralized | | Number |
| | Correction | gNB-CU | unit, Next | HHO | Hard Handover |
| FFS | For Further Study | | Generation NodeB | HLR | Home Location |
| FFT | Fast Fourier | | centralized unit | | Register |
| | Transformation | gNB-DU | gNB-distributed unit, | HN | Home Network |
| feLAA | further enhanced | | Next Generation | HO | Handover |
| | Licensed Assisted | | NodeB distributed | HPLMN | Home |
| | Access, further | | unit | | Public Land Mobile |
| | enhanced LAA | GNSS | Global Navigation | | Network |
| FN | Frame Number | | Satellite System | HSDPA | High |
| FPGA | Field-Programmable | GPRS | General Packet | | Speed Downlink |
| | Gate Array | | Radio Service | | Packet Access |
| FR | Frequency Range | GSM | Global System for | HSN | Hopping |
| G-RNTI | GERAN Radio | | Mobile | | Sequence Number |
| | Network Temporary | | Communications | HSPA | High Speed Packet |
| | Identity | | Groupe Spécial | | Access |
| GERAN | Radio Access | | Mobile | HSS | Home Subscriber |
| GSM | Network | GTP | GPRS Tunneling | | Server |
| EDGE | | | Protocol for User | HSUPA | High Speed Uplink |
| RAN, | | | Plane | | Packet Access |
| GSM | | GTP- | Tunnelling Protocol | HTTP | Hyper Text |
| EDGE | | UGPRS | for User Plane | | Transfer protocol |
| GGSN | Gateway GPRS | GTS | Go To Sleep | HTTPS | Hyper Text Transfer |
| | Support Node | | Signal (related to | | Protocol Secure (https |
| GLONASS | GLObal'naya | | WUS) | | is |
| | NAvigatsionnaya | GUMMEI | Globally Unique | ISDN | Integrated Services |
| | http/1.1 over SSL, | | MME Identifier | | Digital Network |
| | i.e. port 443) | IMC | IMS Credentials | ISIM | IM Services |
| I-Block | Information Block | IMEI | International Mobile | | Identity Module |
| ICCID | Integrated Circuit | | Equipment Identity | ISO | International |
| | Card Identification | IMGI | International mobile | | Organisation for |
| IAB | Integrated Access | | group identity | | Standardisation |
| | and Backhaul | IMPI | IP Multimedia | ISP | Internet Service |
| ICIC | Inter-Cell | | Private Identity | | Provider |
| | Interference | IMPU | IP Multimedia | IWF | Interworking-Function |
| | Coordination | | PUblic identity | I-WLAN | Interworking |
| ID | Identity, identifier | IMS | IP Multimedia | WLAN | Constraint length |
| IDFT | Inverse Discrete | | Subsystem | | of the convolutional |
| | Fourier Transform | IMSI | International | | code, USIM Individual |
| IE | Information | | Mobile Subscriber | | key |
| | element | | Identity | kB | Kilobyte (1000 bytes) |
| IBE | In-Band Emission | IoT | Internet of Things | kbps | kilo-bits per second |
| IEEE | Insitute of Electrical | IP | Internet Protocol | Kc | Ciphering key |
| | and Electronics | Ipsec | IP Security, | Ki | Individual subscriber |
| | Engineers | | Internet Protocol | | authentication key |
| IEI | Information Element | | Security | KPI | Key Performance |
| | Identifier | IP-CAN | IP-Connectivity | | Indicator |
| IEIDL | Information | | Access Network | KQI | Key Quality |
| | Element Identifier | IP-M | IP Multicasr | | Indicator |
| | Data Length | IPv4 | Internet Protocol | KSI | Key Set Identifier |
| IETF | Internet | | Version 4 | ksps | kilo-symbols per |
| | Engineering Task | IPv6 | Internet Protocol | MBSFN | Multimedia Broadcast |
| | Force | | Version 6 | | multicast service |
| IF | Infrastructure | IR | Infrared | | Single Frequency |
| IM | Interference | IS | In Sync | | Network |
| | Measurement, | IRP | Integration | MCC | Mobile Country Code |
| | Intermodulation, | | Reference Point | MCG | Master Cell Group |
| KVM | Kernel Virtual | LTE | Long Term | MCOT | Maximum Channel |
| | Machine | | Evolution | | Occupancy Time |
| L1 | Layer 1 (physical | LWA | LTE-WLAN | MCS | Modulation and |
| | layer) | | aggregation | | coding scheme |
| L1-RSRP | Layer 1 reference | LWIP | LTE/WLAN | MDAF | Management Data |
| | signal recieved | | Radio Level | | Analytics Function |
| | power | | Integration with | MDAS | Management Data |
| L2 | Layer 2 (data link | | IPsec Tunnel | | Analytics Service |
| | layer) | LTE | Long Term Evolution | MDT | Minimization of |
| L3 | Layer (network | M2M | Machine-to-Machine | | Drive Tests |
| | layer) | MAC | Medium Access | ME | Mobile Equipment |
| LAA | License Assisted | | Control (protocol | MeNB | master eNB |
| | Access | | Control (protocol | MER | Message Error Ratio |
| LAN | Local Area Network | | layer context) | MGL | Measurement Gap |
| LBT | Listen Before Talk | MAC | Message | | Length |
| LCM | LifeCycle | | authentication code | MGRP | Measurement Gap |
| | Management | | (security/encryption | | Repetition Period |
| LCR | Low Chip Rate | | context) | MIB | Master Information |
| LCS | Location Services | MAC-A | MAC used for | | Block, Management |
| LCID | Logical Channel ID | | authentication and | | Information Base |
| LI | Layer Indicator | | key agreement | MIMO | Multiple Input Multiple |
| LLC | Logical Link | | (TSG T WG3 | | Output |
| | Control Low Layer | | context) | NC-JT | Non-Coherent Joint |
| | Compatibility | MAC- | used for data integrity | | Transmission |
| LPLMN | Local PLMN | IMAC | of signalling | NEC | Network Capability |
| LPP | LTE Positioning | | messages (TSG T | | Exposure |
| | Protocol | | WG3 context) | NE-DC | NR-E-UTRA Dual |
| LSB | Least Significant | MANO | Management and | | Connectivity |
| | Bit | | Orchestration | NEF | Network Exposure |
| MLC | Mobile Location | MBMS | Multimedia | | Function |
| | Centre | | Broadcast and Multi- | NF | Network Function |
| MM | Mobility Management | | cast Service | NFP | Network Forwarding |
| MME | Mobility Management | MSI | Minimum System | | Path |
| | Entity | | Information, | NFPD | Network Forwarding |
| MN | Master Node | MCH | Scheduling | | Path Descriptor |
| MnS | Management | | Information | NFV | Network Functions |
| | Service | MSID | Mobile Station | | Virtualization |
| MO | Measurement | | Identifier Number | NFVI | NFV Infrastructure |
| | Object, Mobile | MSISDN | Mobile Subscriber | MFVO | NFV Orchestrator |
| | Originated | | ISDN Number | NG | Next Generation, |
| MPBCH | MTC Physical | MT | Mobile Terminated, | | Next Gen |
| | Broadcast CHannel | | Mobile Termination | NGEN-DC | NG-RAN |
| MPDCCH | MTC Physical | MTC | Machine-Type | E-UTRA- | Dual Connectivity |
| | Downlink Control | | Communications | NR | |
| | CHannel | mMTC | massive MTC, | NM | Network Manager |
| MPDSCH | MTC Physical | | massive Machine- | NMS | Network |
| | Downlink Shared | | Type Communications | | Management System |
| | CHannel | MU-MIMO | Multi User | N-PoP | Network Point of |
| MPRACH | MTC Physical | MIMO | MWUS MTC | | Presence |
| | Random Access | | wake-up signal, MTC | NMIB, | Narrowband MIB |
| | CHannel | | WUS | N-MIB | |
| MPUSCH | MTC Physical | NACK | Negative | OSI | Other System |
| | Uplink Shared | | Acknoledgement | | Information |
| | Channel | NAI | Network Access | OSS | Operations Support |
| MPLS | MultiProtocol | | Identifier | | System |
| | Label Switching | NAS | Non-Access | OTA | over-the-air |
| MS | Mobile Station | | Stratum, Non- | PAPR | Peak-to-Average |
| MSB | Most Significant | | Access Stratum | | Power Ratio |
| | Bit | | layer | PAR | Peak to Average Ratio |
| MCS | Mobile Switching | NCT | Network Connectivity | PBCH | Physical Broadcast |
| | Centre | | Topology | | Channel |
| NPBCH | Narrowband Physical | NS | Network Service | PC | Power Control, |
| | Broadcast CHannel | NSA | Non-Standalone | | Personal Computer |
| NPDCCH | Narrowband | | operation mode | PCC | Primary Component |
| | Physical Downlink | NSD | Network Service | | Carrier, Primary CC |
| | Control CHannel | | Descriptor | PCell | Primary Cell |
| NPDSCH | Narrowband | NSR | Network Service | PCI | Physical Cell ID, |
| | Physical Downlink | | Record | | Physcial Cell |
| | Shared CHannel | NSSAI | Network Slice | | Identity |
| NPRACH | Narrowband | | Selection Assistance | PCEF | Policy and Charging |
| | Physical Random | | Information | | Enforcement Function |
| | Access CHannel | S-NNSAI | Single-NSSAI | PCF | Policy Control |
| NPUSCH | Narrowband | NSSF | Network Slice | | Function |
| | Physical Uplink | | Selection Function | PCRF | Policy Control |
| | Shared CHannel | NW | Network | | and Charging Rules |
| NPSS | Narrowband | NWUS | Narrowband | | Function |
| | Primary | | wake-up signal, | PDCP | Packet Data |
| | Synchronization | | Narrowband WUS | | Convergence Protocol, |
| | Signal | NZP | Non-Zero Power | | Packet Data |
| NSSS | Narrowband | O&M | Operation and | | Convergence |
| | Secondary | | Maintenance | | Protocol layer |
| | Synchronization | ODU2 | Optical channel | PSSCH | Physical Sidelink |
| | Signal | | Data Unit- type 2 | | Shared Channel |
| NR | New Radio, | OFDM | Orthogonal | PSCell | Primary SCell |
| | Neighbour Relation | | Frequency Division | PSS | Primary Synchronization |
| NRF | NF Repository | | Multiplexing | | Signal |
| | Function | OFDMA | Orthogonal | PSTN | Public Switched |
| NRS | Narrowband | | Frequency Division | | Telephone Network |
| | Reference Signal | | Multiple Access | PT-RS | Phase-tracking reference |
| PDCCH | Physical Downlink | OOB | Out-of-band | | signal |
| | Control Channel | OOS | Out of Sync | PTT | Push-to-Talk |
| PDCP | Packet Data | OPEX | OPerating | PUCCH | Physical Uplink |
| | Convergence Protocol | | EXpense | | Control Channel |
| PDN | Packet Data Network, | PNFR | Physical Network | PUSCH | Physical Uplink |
| | Public Data Network | | Function Record | | Shared Channel |
| PDSCH | Physical Downlink | POC | PTT over Cellular | QAM | Quadrature Amplitude |
| | Shared Channel | PP, PTP | Point-to-Point | | Modulation |
| PDU | Protocol Data | PPP | Point-to-Point | QCI | QoS class of |
| | Unit | | Protocol | | identifier |
| PEI | Permanent | PRACH | Physcial RACH | QCL | Quasi co-location |
| | Equipment Identifiers | PRB | Physical resource | QFI | QoS Flow ID, |
| PFD | Packet Flow | | block | Qos Flow | Flow Identifier |
| | Description | PRG | Physical resource | QoS | Quality of Service |
| P-GW | PDN Gateway | | block group | QPSK | Quadrature |
| PHICH | Physical hybrid- | ProSe | Proximity | | (Quaternary) Phase |
| | ARQ indicator | | Services, Proximity- | | Shift Keying |
| | channel | | Based Service | QZSS | Quasi-Zenith |
| PHY | Physical layer | PRS | Positioning | | Satellite System |
| PLMN | Public Land | | Reference Signal | RA-RNTI | Random Access RNTI |
| | Mobile Network | PRR | Packet Reception | RRM | Radio Resource |
| PIN | Personal | | Radio | | Management |
| | Identification | PS | Packet Services | RS | Reference Signal |
| | Number | PSBCH | Physical | RSRP | Reference Signal |
| PM | Performance | | Sidelink Broadcast | | Recieved Power |
| | Measurement | | Channel | RSRQ | Reference Signal |
| PMI | Precoding Matrix | PSDCH | Physical | | Received Quality |
| | Indicator | | Sidelink Downlink | RSSI | Received Signal |
| PNF | Physical Network | | Channel | | Strength Indicator |
| | Function | PSCCH | Physical | RSU | Road Side Unit |
| PNFD | Physical Network | | Sidelink Control | RSTD | Reference Signal |
| | Function Descriptor | | Channel | | Time difference |
| RAB | Radio Access | PSFCH | Physical Sidelink | RTP | Real Time Protocol |
| | Bearer, Random | | Feedback Channel | RTS | Ready-To-Send |
| Access | | RLC | Radio Link Control, | RTT | Round Trip Time |
| Burst | | | Radio Link Control | Rx | Reception, Receiving, |
| Rach | Random Access | | layer | | Receiver |
| | Channel | RLC AM | RLC Acknowledge | S1AP | S1 Application Protocol |
| RADIUS | Remote | | Mode | S1-MME | S1 for the control plane |
| | Authentication Dial | RLC UM | RLC | S1-U | S1 for the user plane |
| | in User Service | | Unacknowledge | S-GW | Serving Gateway |
| RAN | Radio Access | | Mode | S-RNTI | SRNC Radio Network |
| | Network | RLF | Radio Link Failure | | Temporary Identity |
| RAND | RANDom number | RLM | Radio Link | S-TMSI | SAE Temporary Mobile |
| | (used for | | Monitoring | | Station Identifier |
| | authentication) | RLM-RS | Reference Signal | SA | Standalone operation |
| RAR | Random Access | | for RLM | | mode |
| | Response | RM | Registration | SiP | System in Package |
| RAT | Radio Access | | Management | SL | Sidelink |
| | Technology | RMC | Reference | SLA | Service Level |
| RAU | Routing Area Update | | Measurement Channel | | Agreement |
| RB | Resource block, | RMSI | Remaining MSI, | SM | Session Management |
| | Radio Bearer | | Remaining Minimum | SMF | Session Management |
| RBG | Resource block group | | System Information | | Function |
| REG | Resource Element | RNC | Radio Network | SMS | Short Message Service |
| | Group | | Controller | SMSF | SMS Function |
| Rel | Release | RNL | Radio Network | SMTC | SSB-based Measurement |
| REQ | REQuest | | Layer | | Timing Configuration |
| RF | Radio Frequency | RNTI | Radio Network | SN | Secondary Node, |
| RI | Rank Indicator | | Temporary Identifier | | Sequence Number |
| RIV | Resource indicator | ROHC | RObust Header | SoC | System on Chip |
| | value | | Compression | SON | Self-Organizing Network |
| RL | Radio Link | RRC | Radio Resource | SpCell | Sepcial Cell |
| SAE | System Architecture | | Control, Radio | SP-CSI- | Semi-Persistent CSI |
| | Evolution | | Resource Control | RNTI | RNTI |
| SAP | Service Access Point | | layer | SPS | Semi-Persistent |
| SAPD | Service Access | SDP | Session Description | | Scheduling |
| | Point Descriptor | | Protocol | SQN | Sequence number |
| SAPI | Service Access | SDSF | Structured Data | SR | Scheduling Request |
| | Point Identifier | | Storage Function | SRB | Signalling Radio Bearer |
| SCC | Secondary | SDU | Service Data Unit | SRS | Sounding Reference |
| | Component Carrier, | SEAF | Security Anchor | | Signal |
| | Secondary CC | | Function | SS | Synchronization Signal |
| SCell | Secondary Cell | seNB | secondary eNB | TPC | Transmit Power Control |
| SC-FDMA | Single Carrier | SEPP | Security Edge | TPMI | Transmitted Precoding |
| | Frequency Division | | Protection Proxy | | Matrix Indicator |
| | Multiple Access | SFI | Slot format indication | TR | Technical Report |
| SCG | Seondary Cell Group | SFTD | Space-Frequency | TRP, TRxP | Transmission Reception |
| SCM | Security Context | | Time Diversity, SFN | | Point |
| | Management | | and frame timing | TRS | Tracking Reference |
| SCS | Subcarrier Spacing | | difference | | Signal |
| SCTP | Stream Control | SFN | System Frame | TRx | Transceiver |
| | Transmission Protocol | | Number or Single | TS | Technical Specifications, |
| SDAP | Service Data | | Frequency Network | | Technical Standard |
| | Adaption Protocol, | SgNB | Secondary gNB | TTI | Transmission Time |
| | Service Data Adaptation | SGSN | Serving GPRS | | Interval |
| | Protocol layer | | Support Node | Tx | Transmission, |
| SDL | Supplementary | SI | System Information | | Transmitting, Transmitter |
| | Downlink | | RNTI | U-RNTI | UTRAN Radio Network |
| SDNF | Structured Data | SIB | System Information | | Temporary Identity |
| | Stroage Network | | Block | UART | Universal Asynchronus |
| | Function | SIM | Subscriber | | Receiver and Transmitter |
| SSB | SS Block | | Identity Module | UCI | Uplink Control |
| SSBRI | SSB Resource | SIP | Session Inititated | | Information |
| | Inidcator | | Protocol | UE | User Equipment |
| SSC | Session and Service | TA | Timing Advance, | UDM | Unified Data Management |
| | Continuity | | Tracking Area | VoIP | Voice-over-IP, Voice- |
| SS-RSRP | Synchronization | TAC | Tracking Area Code | | over- Internet Protocol |
| | Signal based Reference | TAG | Timing Advance | VPLMN | Visited Public Land |
| | Signal Received | TAU | Tracking Area Update | | Mobile Network |
| | Power | TB | Transport Block | VPN | Virtual Private Network |
| SS-RSRQ | Synchronization | TBS | Transport Block | VRB | Virtual Resource Block |
| | Singal based Reference | | Size | WiMAX | Worldwide Interoperability |
| | Signal Received | TBD | To Be Defined | | for Microwave Access |
| | Quality | TCI | Transmission | WLAN | Wireless Local Area |
| SS-SINR | Synchronization Signal | | Configuration Indicator | | Network |
| | based Signal to Noise | | Protocol | WMAN | Wireless Metropolitan |
| | and Interference Ratio | TDD | Time Division Duplex | | Area Network |
| SSS | Secondary | TDM | Time Division | WPAN | Wireless Personal Area |
| | Synchronization Signal | | Multiplexing | | Network |
| SSSG | Search Space Set Group | TDMA | Time Division | X2-C | X2-Control plane |
| SSSIF | Search Space Set | | Multiple Access | X2-U | X2-User plane |
| | Indicator | TW | Terminal Equipment | XML | eXtensible Markup |
| SST | Slice/Service Types | TEID | Tunnel End Point | | Language |
| SU-MIMO | Single User MIMO | | Identifier | XRES | EXpected user |
| SUL | Supplementary Uplink | TFT | Traffic Flow Template | | RESponse |
| UDP | User Datagram Protocol | TMSI | Temporary Mobile | XOR | eXclusive OR |
| UDR | Unified Data | | Subscriber | ZC | Zadoff-Chu |
| | Repository | TNL | Transport Network | ZP | Zero Power |
| UDSF | Unstructured Data | | Layer | | |
| | Storage Network | USS | UE-specific search | | |
| | Function | | space | | |
| UICC | Universal Integrated | UTRA | UMTS Terrestrial | | |
| | Circuit Card | | Radio Access | | |
| UL | Uplink | UTRAN | Universal Terrestrial | | |
| UM | Unacknowledged | | Radio Access Network | | |
| | Mode | UqPTS | Uplink Pilot Time | | |
| UML | Unified Modelling | | Slot | | |
| | Language | V2I | Vehicle-to- | | |
| UMTS | Universal Mobile | | Infrastruction | | |
| | Telecommunications | V2P | Vehicle-to-Pedestrian | | |
| | System | V2V | Vehicle-to-Vehicle | | |
| UP | User Plane | V2X | Vehicle-to-everything | | |
| UDF | User Plane Function | VL | Virtual Link, | | |
| URI | Uniform Resource | VLAN | Virtual LAN, | | |
| | Identifier | | Virtual Local Area | | |
| URL | Uniform Resource | | Network | | |
| | Locator | VM | Virtual Machine | | |
| URLLC | Ultra-Reliable and | VNF | Virtualized Network | | |
| | Low Latency | | Function | | |
| USB | Universal Serial Bus | VNFFG | VNF Forwarding | | |
| USIM | Universal Subscriber | | Graph | | |
| | Identity Module | VNFFGD | VNF Forwarding | | |
| | | | Graph Descriptor | | |
| | | VNFM | VNF Manager | | |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “application” may refer to a complete and deployable package, environment to achieve a certain function in an operational environment. The term “AI/ML application” or the like may be an application that contains some AI/ML models and application-level descriptions.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1-19. (canceled)

20. An apparatus comprising:
memory to store updated radio access network (RAN) user equipment (UE) identification (ID) information; and
processing circuitry, coupled with the memory, to:
receive, from a near-real time RAN intelligent controller (near-RT RIC), a subscription or request for the updated RAN UE ID information;
retrieve the updated RAN UE ID information from the memory; and
encode a message for transmission to the near-RT RIC that includes the updated RAN UE ID information.

21. The apparatus of claim 20, wherein the updated RAN UE ID information is represented by an octet string.

23. The apparatus of claim 21, wherein the octet string has a size of eight characters.

24. The apparatus of claim 20, wherein the message is encoded for transmission via an E2 interface.

25. The apparatus of claim 20, wherein the subscription or request is received via an E2 interface.

26. The apparatus of claim 20, wherein the apparatus comprises a next-generation NodeB (gNB) implementing a control unit-control plane (CU-CP).

27. The apparatus of claim 26, wherein the gNB further implements a distributed unit (DU) and a control unit-user plane (CU-UP).

28. One or more non-transitory computer-readable media storing instructions that, when executed by one or more processors, cause a next-generation NodeB (gNB) to:
receive, from a near-real time RAN intelligent controller (near-RT RIC), a subscription or request for updated radio access network (RAN) user equipment (UE) identification (ID) information;
determine the updated RAN UE ID information in response to the subscription or request; and
encode a message for transmission to the near-RT RIC that includes the updated RAN UE ID information.

29. The one or more non-transitory computer-readable media of claim 28, wherein the updated RAN UE ID information is represented by an octet string.

30. The one or more non-transitory computer-readable media of claim 29, wherein the octet string has a size of eight characters.

31. The one or more non-transitory computer-readable media of claim 28, wherein the message is encoded for transmission via an E2 interface.

32. The one or more non-transitory computer-readable media of claim 28, wherein the subscription or request is received via an E2 interface.

33. The one or more non-transitory computer-readable media of claim 28, wherein the gNB implements a control unit-control plane (CU-CP).

34. The one or more non-transitory computer-readable media of claim 33, wherein the gNB further implements a distributed unit (DU) and a control unit-user plane (CU-UP).

35. One or more non-transitory computer-readable media storing instructions that, when executed by one or more processors, cause a near-real time RAN intelligent controller (near-RT RIC) to:
encode a message to a next-generation NodeB (gNB) that includes a subscription or request for updated radio access network (RAN) user equipment (UE) identification (ID) information; and
receive, over an E2 interface, a response that includes the updated RAN UE ID information.

36. The one or more non-transitory computer-readable media of claim 35, wherein the updated RAN UE ID information is represented by an octet string.

37. The one or more non-transitory computer-readable media of claim 36, wherein the octet string has a size of eight characters.

38. The one or more non-transitory computer-readable media of claim 35, wherein the message is encoded for transmission via an E2 interface.

39. The one or more non-transitory computer-readable media of claim 35, wherein the message is directed to a control unit-control plane (CU-CP) implemented by the gNB.
